(19) United States
(12) Patent Application Publication
(10) Pub. No.: US 2015/0352671 A1
(43) Pub. Date: Dec. 10, 2015

(54) LASER CUTTING SAME SIDE SLUG REMOVAL

(71) Applicant: GM GLOBAL TECHNOLOGY OPERATIONS LLC, DETROIT, MI (US)

(72) Inventor: Ayad K. Darzi, Grand Blanc, MI (US)

(73) Assignee: GM GLOBAL TECHNOLOGY OPERATIONS LLC, DETROIT, MI (US)

(21) Appl. No.: 14/299,534

(22) Filed: Jun. 9, 2014

(51) Int. Cl. B23K 26/38; B23K 26/08

(52) U.S. Cl. CPC B23K 26/383; B23K 26/08

(57) ABSTRACT

A method of laser cutting a slug from a workpiece may include angling a laser cutting head other than perpendicular relative to a cutting surface of a layer of the workpiece from which the slug will be cut, laser cutting the slug from the layer, with the slug having a wider portion on the cutting surface than a portion of the slug on a backside surface of the layer, and removing the slug from the layer through the cutting surface side of the layer.

### BACKGROUND OF INVENTION

The present invention relates generally to laser cutting.

While laser cutting of an workpiece with an enclosed cavity or otherwise inaccessible back side, a concern arises that a slug will drop within the cavity (or other inaccessible area) of the finished workpiece, making it difficult to remove. Or, the slug may fall through a workpiece into a fixture holding the workpiece, creating concerns with loose slugs in the fabrication or assembly area of a production facility. Such a trapped or loose slug may create the potential for rattle or other concerns. This may occur even if the laser is cutting a slug from a vertically oriented surface or from below the surface due to gas pressure from the laser cutting process that may push the slug into the cavity or fixture.

In attempts to overcome this concern, some methods laser cut around most but not all of the slug and then finish the cut with the slug secured by a magnetic assist. But this requires a magnetic type of metal being cut and adds extra steps and complexity to the laser cutting process, which might not always be desirable. Another way some have attempted to overcome this concern is to laser cut the slug before assembly of the workpiece that creates the cavity/inaccessibility. But this is not always desirable, and does not solve concerns with fixtures. Still others have attempted to overcome this concern by using a vacuum to retain and remove the slugs during the laser cutting process. But this technique has not always been reliable and adds complexity to the cutting process.

### SUMMARY OF INVENTION

An embodiment contemplates a method of laser cutting a slug from a workpiece including: angling a laser cutting head other than perpendicular relative to a cutting surface of a layer from which the slug will be cut; laser cutting the slug from the layer, with the slug having a wider portion on the cutting surface than a portion of the slug on a backside surface of the layer; and removing the slug from the layer through the cutting surface side of the layer.

An advantage of an embodiment is that slugs cut out from a workpiece during a laser cutting process are reliably prevented from falling into a cavity or other inaccessible area relative a workpiece, while being easy to remove the slug from the workpiece from the same side as the cut. This avoids concerns with slugs rattling inside a cavity of a workpiece as well as concerns with loose slugs in fixtures. Additionally, this laser cutting process allows for minimizing the steps in the laser cutting and slug removal process for different cutting situations, which may minimize cost, complexity and cycle times for processing workpieces, while substantially eliminating concerns with human error in the cutting process allowing for the slugs ending up in the undesirable locations.

### BRIEF DESCRIPTION OF DRAWINGS

FIG. 1 is a schematic, partial cross-sectional view of a laser cutting operation before cutting of a workpiece.

FIG. 2 is similar to FIG. 1, but with the cutting process partially completed.

FIG. 3 is similar to FIG. 1, but with the cutting process essentially completed.

FIG. 4 is similar to FIG. 1, but with the cutting process essentially completed.

FIG. 5 is similar to FIG. 1, but with the cutting process essentially completed and the laser cutting from underneath the workpiece.

### DETAILED DESCRIPTION

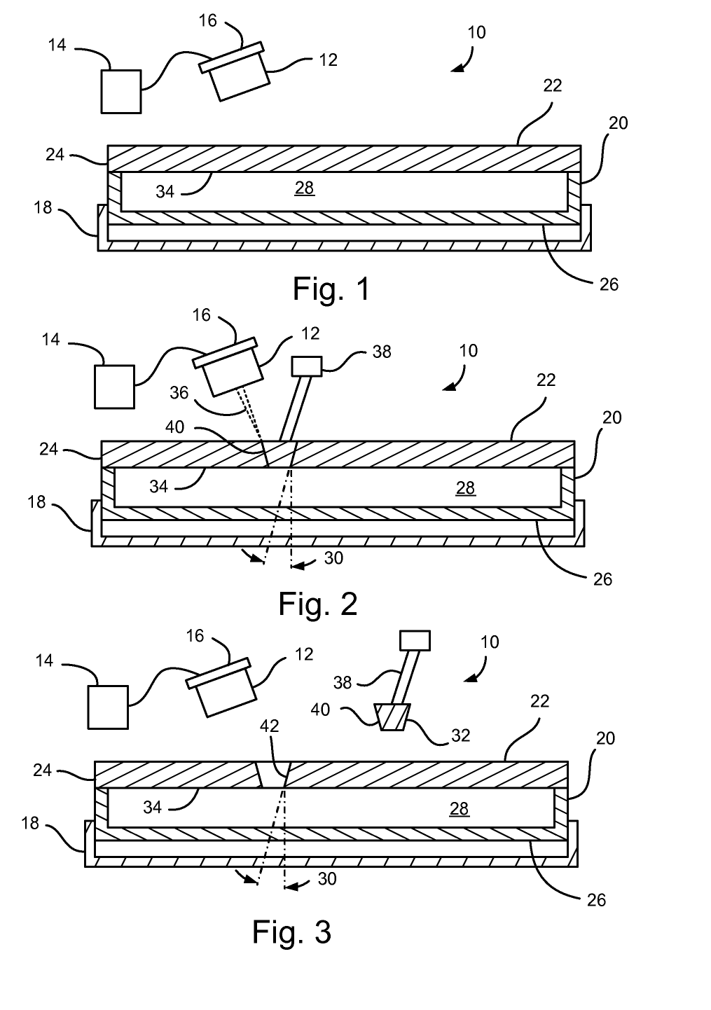

Referring to FIG. 1, a laser cutting assembly, indicated generally at 10, is shown. The assembly 10 includes a laser cutting head 12 and head movement actuator 16 controlled by a controller 14, which controls the activation and movement of the laser cutting head 12. The laser cutting head 12, head movement actuator 16 and controller 14 may be conventional and so will not be discussed further herein.

A fixture 18 secures a workpiece 20 in position for the laser cutting process. The workpiece 20 includes a cutting surface 22 on the layer 24 to be laser cut, and may include a back layer 26 that creates a cavity 28 within the workpiece 20. The layer 24 and back layer 26 may be two separate pieces that are secure together by, for example, welding, adhesive, hemming, riveting or other fasteners, or may be a single piece that is folded over onto itself. The workpiece may also include only the layer 24, without any cavity, but with a potential for a slug to drop into the fixture 18. Additionally, it is known in the art for the fixture 18 to move the workpiece 20 relative to a generally stationary laser cutting head 12. One or both of the fixture 18 or the laser cutting head 12 may tilt to achieve the desired angle of cut (discussed below) during the laser cutting process.

FIGS. 2-5 are similar to FIG. 1 and so like element numbers represent like elements, the description of which will not be repeated for FIGS. 2-5. The figures will now be discussed relative to the laser cutting process.

FIG. 1 shows the workpiece 20, prior to cutting, mounted in the fixture 18 adjacent to the laser cutting head 12, with the cutting surface 22 facing the head 12. The laser cutting head 12 is angled relative to the cutting surface 22 so that the laser is not at ninety degrees to the surface 22. The angle 30 is defined and used herein as the orientation of the laser relative to perpendicular to the cutting surface 22. Moreover, the angle 30 as defined and used herein is the angle from perpendicular where the angle causes the diameter or width of a slug 32 (shown in FIGS. 2-5) to be wider on the cutting surface 22 than on a backside surface 34 of the layer 24 to be laser cut.

FIG. 2 illustrates the laser cutting assembly 10 with the cutting process partially completed and FIG. 3 illustrates the laser cutting assembly 10 with the cut complete and the slug 32 removed. The laser cutting head 12 produces a laser beam 36 that cuts through the layer 24 at the angle 30 from perpendicular, with the finished cut producing the slug 32 to be removed. Optionally, a slug remover 38 may be in contact with the slug 32 to remove it once the cut is finished. This slug remover 38 may be a magnet, for layers made of magnetic materials, a vacuum, or some other type of means for securing and removing the slug 32. The angle 30 of the laser cut automatically creates a slug 32 with a side wall 40 the prevents the slug 32 from dropping into the cavity 28 of the workpiece 20 or into the fixture 18 through the hole 42 created in the layer 24, even if the slug remover 38 from time to time does not securely retain the slug 32 during the cutting and/or removal process. The side wall 40 being angled in this way may also make it easier to pull the slug 32 from the layer 24. The slug 32 may have truncated conical shape or may be a shape that has generally rectangular or other cross section, so long as the cutting surface width is greater than the width of the backside surface of the slug.

The angle 30 of the cut may be, for example, about fifteen degrees from perpendicular, but may be as low as about ten degrees or higher up to about 20 or 30 degrees. This laser cut is not perpendicular to the cutting surface 22 as is standard for laser cutting slugs, so the laser cut parameters for a perpendicular cut generally will not work. The laser cut parameters are changed to account for the angle 30. For example, if the cutting angle is fifteen degrees, a Rayleigh Length for the cut should be a minimum of about double the thickness of the layer 24 being laser cut (as opposed to standard perpendicular laser cutting where the Rayleigh Length used may be as long as a single thickness of the layer to be cut). In addition, the numerical aperture (na) is desired to be lower than 0.1 for laser cutting at the angle 30 of fifteen degrees (as opposed to standard perpendicular laser cut where the numerical aperture (na) value is over 0.1. Additionally, for the example of the cutting angle 30 being fifteen degrees, a spot diameter is desired to be smaller than 0.2 (as opposed to standard perpendicular laser cutting where the spot diameter is typically between 0.5 to 0.4).

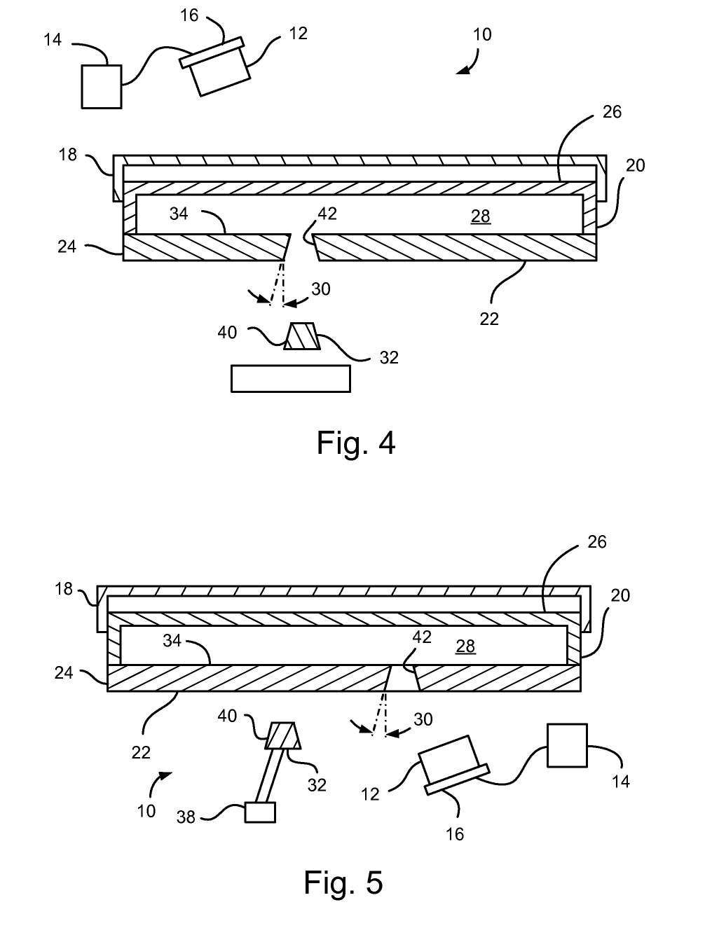

FIG. 4 illustrates the laser cutting assembly 10 with the cutting process completed but where the fixture 18 or other mechanism tips over the workpiece 20 after finishing the laser cut to use gravity to dump the slug 32 into a slug retainer 44. The laser cutting process may otherwise be the same as the other figures. Again, the slug 32 is prevented from dropping into the cavity 28 after cutting and while being tipped over to dump out the slug 32.

FIG. 5 illustrates the laser cutting assembly 10 with the cutting process completed but where the fixture 18 secures the workpiece 20 with the cutting surface 22 facing in a downward direction and the laser cutting head 12 cutting from below the workpiece 20. A slug remover 38 may be employed or a gravity drop may be employed, as desired for the particular situation.

While certain embodiments of the present invention have been described in detail, those familiar with the art to which this invention relates will recognize various alternative designs and embodiments for practicing the invention as defined by the following claims.

1. A method of laser cutting a slug from a workpiece comprising:
(a) angling a laser cutting head other than perpendicular relative to a cutting surface of a layer of the workpiece from which the slug will be cut;
(b) laser cutting the slug from the layer, with the slug having a wider portion on the cutting surface than a portion of the slug on a backside surface of the layer; and
(c) removing the slug from the layer through the cutting surface side of the layer.

2. The method of claim 1 further comprising:
(d) prior to step (c), securing a slug remover to the cutting surface from which the slug will be cut, and employing the slug remover during step (c) to remove the slug.

3. The method of claim 2 wherein the slug remover is a magnet attached to the cutting surface of the layer.

4. The method of claim 2 wherein the slug remover is a vacuum secured to the cutting surface of the layer.

5. The method of claim 1 wherein the slug is a truncated conical shape.

6. The method of claim 5 wherein the angle of the cutting head relative to the cutting surface is between ten and twenty degrees.

7. The method of claim 1 wherein the angle of the cutting head relative to the cutting surface is between ten and twenty degrees.

8. The method of claim 1 wherein the angle of the cutting head relative to the cutting surface is about fifteen degrees.

9. The method of claim 8 wherein step (b) is further defined by a Rayleigh Length for the laser cut being at least double the thickness of the layer being laser cut.

10. The method of claim 9 wherein step (b) is further defined by a numerical aperture being lower than 0.1 for the laser cutting.

11. The method of claim 8 wherein step (b) is further defined by a numerical aperture being lower than 0.1 for the laser cutting.

12. The method of claim 1 wherein step (c) is further defined by turning the workpiece such that the cutting face faces generally downward to allow gravity to remove the slug.

13. The method of claim 1 wherein steps (b) and (c) are further defined by the cutting surface facing generally downward during the laser cutting to allow gravity to remove the slug.
